(19) United States
(12) Patent Application Publication
(10) Pub. No.: US 2023/0286010 A1
(43) Pub. Date: Sep. 14, 2023

(54) COATER FOR THE PREPARATION OF CARBON-BASED TAPE SUBSTRATES FOR USE IN IMAGING APPLICATIONS

(71) Applicant: THE UNIVERSITY OF KANSAS, Lawrence, KS (US)

(72) Inventor: Eduardo ROSA-MOLINAR, Lawrence, KS (US)

(21) Appl. No.: 18/020,007

(22) PCT Filed: Aug. 5, 2021
(86) PCT No.: PCT/US2021/044741

§ 371 Date: Feb. 6, 2023

Related U.S. Application Data
(60) Provisional application No. 63/062,280, filed on Aug. 6, 2020.

(51) Int. Cl. B05C 1/08; G01N 23/2202; G01N 23/2251

(52) U.S. Cl. CPC B05C 1/0821; B05C 1/0817; G01N 23/2202; G01N 23/2251

(57) ABSTRACT

Disclosed are reel-to-reel coating systems that can be used to form graphene-coated tapes. The coating systems can be modular, self-contained, and sized to allow for benchtop fabrication of coated tape substrates for use in imaging applications. The reels of the coating system can be removable, and adapted to be re-attached to an in-situ scanning electron microscope reel-to-reel imaging system, a reel-to-reel system for sectioning resin-embedded cells and/or tissues with an ultramicrotome, or any combination thereof. In this way, the coater can serve as part of an integrated system facilitating efficient, serial sample processing and imaging.

### CROSS-REFERENCE TO RELATED APPLICATIONS

This application claims benefit of U.S. Provisional Application No. 63/062,280, filed Aug. 6, 2020, which is hereby incorporated herein by reference in its entirety.

### BACKGROUND

Electron microscopy, which includes, scanning electron microscopy (SEM), transmission electron microscopy (TEM), analytical electron microscopy (AEM), correlative light and electron microscopy (CLEM), serial section transmission electron microscopy (ssTEM), serial section scanning electron microscopy (ssSEM) serial section scanning transmission electron microscopy (ssSTEM) serial block-face scanning electron microscopy (sBFSEM) and scanning transmission electron microscopy (STEM) can be advantageously used to investigate the ultrastructure of biological samples such as cells and tissue, polymer resin samples, and crystalline samples such as inorganic (e.g., iron, zinc, copper, etc.) substances.

In an electron microscope column, incident electrons are accelerated into, for example, epoxy resin-embedded samples (FIG. 1). A number of interactions between the accelerated electrons and atoms contained within the resin-embedded sample result in elastic and inelastic scattering of electrons (known as the electron interaction volume; FIG. 1). A number of signals generated (i.e., secondary electrons, backscattered electrons, cathodoluminescence, auger electrons, characteristic X-rays, and Bremsstrahlung X-rays) can be used for high-resolution electron microscopic imaging of ultrastructural features of cell and tissue organelles.

There are many complications associated with the imaging of non-conductive samples. It is known, for example, that charging can complicate the imaging samples with low conductivity, such as biological samples. Charging is produced by build-up of electrons in a sample and their uncontrolled discharge. This can produce unwanted artifacts, particularly in secondary electron images. When the number of incident electrons is greater than the number of electrons escaping from the specimen, then a negative charge builds up at the point where the beam hits the sample. This phenomenon is called charging, and it causes a range of unusual effects such as abnormal contrast and image deformation and shift. Sometimes a sudden discharge of electrons from a charged area may cause a bright flash on the screen. These make it impossible to capture a uniform image of the specimen and may even be violent enough to cause small specimens to be dislodged from the mounting stub.

Increasing conductivity without influencing the contrast of the embedding medium can be done by using conductive materials composed of light elements. For example, the use of more conductive substrates to mount the specimens for imaging can improve the image quality by eliminating the charging effects. Thus, there is a need for the development of highly conductive substrates to eliminate charging artifacts resulting from the electron beam in electron microscopy (e.g., TEM, SEM, STEM, AEM, CLEM, ssTEM, ssSEM, ssSTEM, sBFSEM). There is also a need for the development of highly conductive substrates that can be effectively invisible in the resolution range for optical (e.g., bright-field, fluorescence, laser scanning confocal microscopy, and multi-photon microscopy) microscopy to transmit light. There is also a need for methods of using such substrates in imaging technology.

Graphene-coated substrates, including graphene-coated tapes, offer the potential to function as conductive substrates for electron microscopy. However, to realize their potential, improved methods of forming these substrates are needed.

### SUMMARY

Provided herein are reel-to-reel coating systems that can be used to form carbon-coated (e.g., graphene-coated) tapes. The coating systems can be modular, self-contained, and sized to allow for benchtop fabrication of coated tape substrates for use in imaging applications. The reels of the coating system can be removable, and adapted to be re-attached to an in-situ scanning electron microscope reel-to-reel imaging system, a reel-to-reel system for sectioning resin-embedded cells and/or tissues with an ultramicrotome, or any combination thereof. In this way, the coater can serve as part of an integrated system facilitating efficient, serial sample processing and imaging. The tapes can also serve as grids for use in imaging.

### DESCRIPTION OF DRAWINGS

FIG. 1 is a schematic illustration showing electron interaction volume within an epoxy resin embedded sample.

FIG. 2 is a schematic illustration showing a side view of an example reel-to-reel coater.

FIG. 3 is a schematic illustration showing a front view of an example reel-to-reel coater.

FIG. 4 is a schematic illustration showing a perspective view of an example reel-to-reel coater.

FIGS. 5A-5B, 6, 7, 8, 9, 10A-10D, 11A-11C, 12, 13, 14A-14B, 15, and 16A-16F are photographs illustrating an example reel-to-reel coater.

FIG. 17 includes micrographs showing a graphene thin film at two different magnifications.

FIGS. 18A-18B show C1s XPS spectra of (FIG. 18A) Kapton tape and (FIG. 18B) graphene-coated Kapton film.

FIG. 19 shows an SEM image and corresponding elemental map of Fe₂O₃ particles on graphene-coated Kapton film using EDX to clearly represent the elemental composition of (panel b) C, (panel c) O and (panel d) Fe.

FIG. 20 shows an S/TEM image and corresponding elemental map of Fe₂O₃ particles on graphene coated Kapton film using EDX to clearly represent the elemental composition of (panel b) C, (panel c) O and (panel d) Fe.

FIG. 21 shows an S/TEM image and corresponding elemental map of Fe₂O₃ particles on the surface of holes punched on graphene-coated Kapton film using EDX to clearly represent the elemental composition of (panel c) O and (panel d) Fe.

FIG. 22 includes TEM images and lattice spacing of Fe₂O₃ particles on the surface of holes punched on graphene-coated Kapton film showing (panel a) the morphology of particles and (panel b) high resolution images of particle representing lattice spacing.

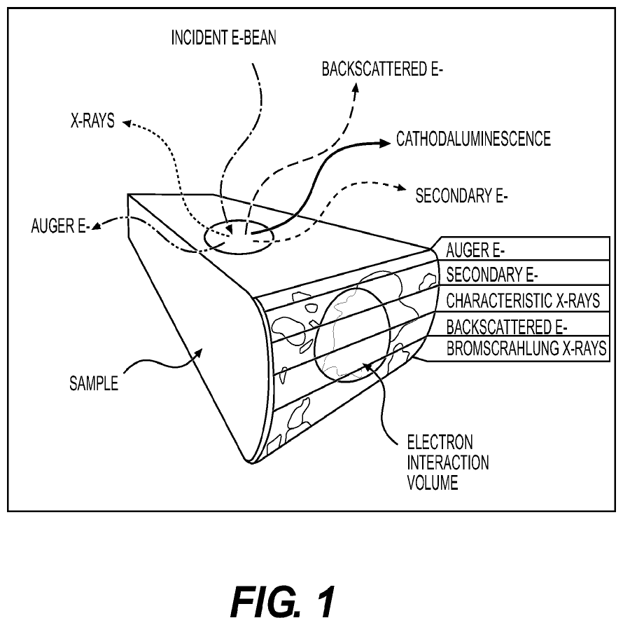

### DETAILED DESCRIPTION

The present invention can be understood more readily by reference to the following detailed description, examples, drawings, and claims, and their previous and following description. However, before the present articles, devices, systems, and/or methods are disclosed and described, it is to be understood that this invention is not limited to the specific or exemplary aspects of articles, devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

As used herein, the singular forms “a,” “an” and “the” include plural referents unless the context clearly dictates otherwise. Thus, for example, reference to a “substrate” includes aspects having two or more such substrates unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

As used herein, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is less than about 1% by weight, e.g., less than about 0.5% by weight, less than about 0.1% by weight, less than about 0.05% by weight, or less than about 0.01% by weight of the stated material, based on the total weight of the composition.

In other aspects, as used herein, the term “substantially free,” when used in the context of a film that is substantially free of perorations, for example, is intended to refer to a film or a layer that has less than about 5% of defects, less than about 4.5% of defects, less than about 4% of defects, less than about 3.5% of defects, less than about 3% of defects, less than about 2.5% of defects, less than about 2% of defects, less than about 1.5% of defects, less than about 1% of defects, less than about 0.5% of defects, less than about 0.1% of defects, less than about 0.05% of defects, or less than about 0.01% of defects of the total surface of the film or the layer.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

Further, the terms “coupled” and “associated” generally means electrically, electromagnetically, and/or physically (e.g., mechanically or chemically) coupled or linked and does not exclude the presence of intermediate elements between the coupled or associated items.

It will be understood that, although the terms “first,” “second,” etc. can be used herein to describe various elements, components, regions, layers and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example aspects.

Spatially relative terms, such as “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

Numerous other general purpose or special purpose computing devices environments or configurations can be used. Examples of well-known computing devices, environments, and/or configurations that can be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer, can be used. Generally, program modules include routines, programs, objects, components, data structures, etc. that perform particular tasks or implement particular abstract data types. Distributed computing environments can be used where tasks are performed by remote processing devices that are linked through a communications network or other data transmission medium. In a distributed computing environment, program modules and other data can be located in both local and remote computer storage media, including memory storage devices.

In its most basic configuration, a computing device typically includes at least one processing unit and memory. Depending on the exact configuration and type of computing device, memory can be volatile (such as random-access memory (RAM)), non-volatile (such as read-only memory (ROM), flash memory, etc.), or some combination of the two.

Computing devices can have additional features/functionality. For example, a computing device can include additional storage (removable and/or non-removable) including, but not limited to, magnetic or optical disks or tape.

Computing device typically includes a variety of computer-readable media. Computer-readable media can be any available media that can be accessed by the device and includes both volatile and non-volatile media, removable and non-removable media.

Computer storage media include volatile and non-volatile, and removable and non-removable media implemented in any method or technology for storage of information such as computer-readable instructions, data structures, program modules or other data. Memory, removable storage, and non-removable storage are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device. Any such computer storage media can be part of a computing device.

Computing devices, as disclosed herein, can contain communication connection(s) that allow the device to communicate with other devices. Computing devices can also have input device(s) such as a keyboard, mouse, pen, voice input device, touch input device, etc. Output device(s) such as a display, speakers, printer, etc. can also be included. All these devices are well known in the art and need not be discussed at length here.

It should be understood that the various techniques described herein can be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, can take the form of program code (i.e., instructions) embodied in tangible media, such as CD-ROMs, hard drives, or any other machine-readable storage medium where, when the program code is loaded into and executed by a machine, such as a computer, the machine becomes an apparatus for practicing the presently disclosed subject matter.

Although the operations of exemplary aspects of the disclosed method can be described in a particular, sequential order for convenient presentation, it should be understood that disclosed aspects can encompass an order of operations other than the particular, sequential order disclosed. For example, operations described sequentially can, in some cases, be rearranged or performed concurrently. Further, descriptions and disclosures provided in association with one particular aspect are not limited to that aspect and can be applied to any aspect disclosed.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

Moreover, for the sake of simplicity, the attached figures cannot show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

The present invention may be understood more readily by reference to the following detailed description of various aspects of the invention and the examples included therein and to the Figures and their previous and following description.

Reel-to-Reel Coaters

Described herein are reel-to-reel coating systems for the fabrication of coated tapes (e.g., coated polyimide tapes). The coating systems can be modular, self-contained, and sized to allow for benchtop fabrication of coated tape substrates for use in imaging applications. The reels of the coating system can be removable, and adapted to be re-attached to an in-situ scanning electron microscope reel-to-reel imaging system, a reel-to-reel system for sectioning resin-embedded cells and/or tissues with an ultramicrotome, or any combination thereof. In this way, the coater can serve as part of an integrated system facilitating efficient, serial sample processing and imaging. Further, the coater can provide precise (e.g., submicron) control over coating thinkness, improving the utility of the coated tapes as conductive substrates for electron microscopy.

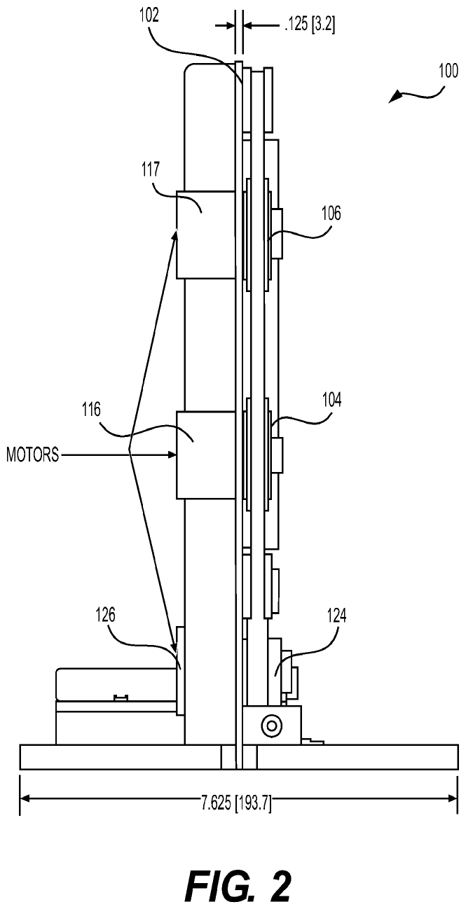

Referring now to FIGS. 2-4, the reel-to-reel coating system (100) can a support frame (102); a feeder reel (104) rotatably coupled to the support frame (102); a feeder motor (116) operably coupled to the feeder reel (104) so as to drive rotation of the feeder reel; a take-up reel (106) rotatably coupled to the support frame (102); and a take-up motor (117) operably coupled to the take-up reel (106) so as to drive rotation of the take-up reel. The system can further comprise a coating element (108), a drying element (110), and a heating element (112), each operably coupled to the support frame (102) and spaced apart from the feeder reel (104), the take-up reel (106), and one another. The system can further comprise one or more tape guides (114) coupled to the support frame (102) and defining a path (128) for a tape (130) to be drawn from the feeder reel (104) to the take-up reel (106). The path (128) can be configured such that the tape (130) sequentially interfaces with the coating element (108), the drying element (110), and the heating element (112) while being drawn from the feeder reel (104) to the take-up reel (106).

The feeder reel, the take-up real, or a combination thereof can be detachably connected to the feeder motor. In this way, reels loaded with a tape can be attached to the coating system, a conductive carbon coating can be applied using the system, and the reels containing the coated tape can be removed from the coating system for use in a reel-to-reel imaging application. In some embodiments, the feeder reel and the take-up reel can be adapted to be re-attached to an in-situ scanning electron microscope reel-to-reel imaging system, a reel-to-reel system for sectioning resin-embedded cells and/or tissues with an ultramicrotome, or any combination thereof. Such systems are described, for example, in PCT Application No. PCT/US20/45239, filed Aug. 6, 2020, entitled “Electron Microscope Imaging Adaptor”; and in PCT Application No. PCT/US20/45233, filed Aug. 6, 2020, entitled “Apparatus and Methods for Ultramicrotome Specimin Preparation,” each of which is hereby incorporated by reference in its entirety.

In some embodiments, the feeder reel and the take-up reel comprise aluminum wheels comprising respective hubs for wrapping the tape, the respective hubs having a calibrated circumference adapted to maintain a speed and a tension of the tape extending between the feeder reel and the take-up reel. In some embodiments, the reels, including the wheels and hubs, can be machined and/or 3D printed, allowing for precise control of dimensions (and by extension coater performance).

In certain embodiments, the feeder reel and the take-up reel comprise wheels comprising respective hubs for wrapping the tape, the wheels and hubs being formed from a material that can be adapted for use in an electron microscope and/or high vacuum. In certain and unlimited aspects, the wheels and hubs can comprise a materials that has predetermined conductivity and predetermined magnetically shielding properties. In yet further exemplary aspects, each of the wheels and hubs comprises aluminum and/or aluminum alloy having predetermined conductivity and predetermined magnetically shielding properties. Other suitable materials can include carbon, copper, chromium, brass, iron, molybdenum, nickel, stainless steel, and titanium alloys.

It certain embodiments, the wheels and hubs can be formed from a material that is capable of withstanding temperatures inside of in-situ electron microscopes that are equipped to use a reel-to-reel imaging system. Such temperatures in the environment of an electron microscope can be in the range up to about 1,500° C., including exemplary values of about 900° C., about 1,000° C., about 1,100° C., about 1,200° C., about 1,300° C., and about 1,400° C. to the range of 1400 degrees Celsius to 1500 degrees Celsius.

In still further aspects, the feeder reel and the take-up reel comprise wheels comprising respective hubs for wrapping the tape that have a calibrated circumference produced by precise machining of the desired materials, such as, for example, and without limitation, aluminum and aluminum alloy. In still further aspects, the wheels are adapted to maintain the first speed and the second speed such that the tape can extend with tension, when desired, between the feeder reel and the take-up reel.

In another embodiment, the take-up real can comprise a reel described above (e.g., adapted to be re-attached to an in-situ scanning electron microscope reel-to-reel imaging system, a reel-to-reel system for sectioning resin-embedded cells and/or tissues with an ultramicrotome, or any combination thereof) while the feeder reel can have different dimensions from the take-up reel, be formed from different materials than the take-up reel, or a combination thereof. In some embodiments, the feeder reel can be larger or smaller than the take-up reel. In some embodiments, the feeder reel can be formed from different materials than the take-up reel. For example, the feeder reel can be formed from a low-cost disposable material (e.g., a plastic) while the take-up reel can be formed from materials that can be adapted for use in an electron microscope and/or high vacuum (e.g., aluminum, carbon, copper, chromium, brass, iron, molybdenum, nickel, stainless steel, titanium, combinations thereof, and alloys thereof). In certain embodiments, the feeder reel can comprise a disposable spool on which the tape to be coated is sold.

The system can comprises any number of tape guides desired to efficiently define a path for the tape to be drawn from the feeder reel to the take-up reel. The path can be configured such that the tape sequentially interfaces with the coating element, the drying element, and the heating element while being drawn from the feeder reel to the take-up reel. In this context, “interface with” refers to the tape passing in proximity to the coating element, the drying element, and the heating element such that the coating element, the drying element, and the heating element, in combination, can effectuate deposition of a conductive carbon coating on a surface of the tape. In some embodiments, interfacing can involve physical contact between the tape and one of these features (e.g., physical contact between the tape and the coating element, physical contact between the tape and the drying element, and/or physical contact between the tape and the heating element). In other embodiments, interfacing can involve passing the tape close to (but not in contact with) one of these features (e.g., close enough to the coating element such that the coating element can apply a coating reagent to a surface of the tape being drawn along the path from the feeder reel to the take-up reel, close enough to the drying element such that the drying element can dry the applied coating reagent, and/or close enough to the heating element such that the heating element can anneal the applied coating reagent).

The combined action of the coating element, the gas diffuser, and the heating element can serve to form a coating. Specifically, the coating element can apply a coating reagent to a surface of the tape, the gas diffuser can dry the applied coating reagent, and the heating element can anneal the applied coating reagent. In some embodiments, the gas diffuser can be absent. For example, the gas diffuser can in principle be omitted when the coating reagent is applied in neat form or when the coating reagent is applied as a solution or suspension which dries in the time it takes for a segment of tape to advance from the coating element to the heating element (e.g., when the solvents used in the coating reagent composition or sufficiently volatile and/or when the path length between the coating element and the heating element is sufficiently long to allow the coating reagent to dry).

The coating element can comprise any structure that is configures to apply a coating reagent to a surface of the tape being drawn along the path from the feeder reel to the take-up reel. For example, the coating element can spray the coating reagent, print (e.g., inkjet print) the coating reagent, or brush the coating reagent on the surface of the tape.

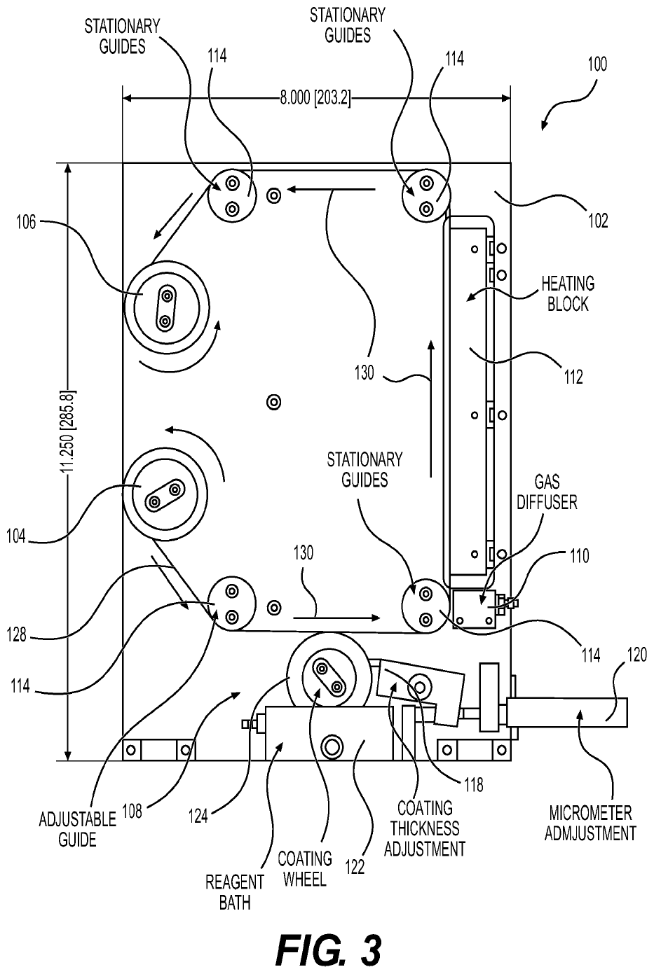

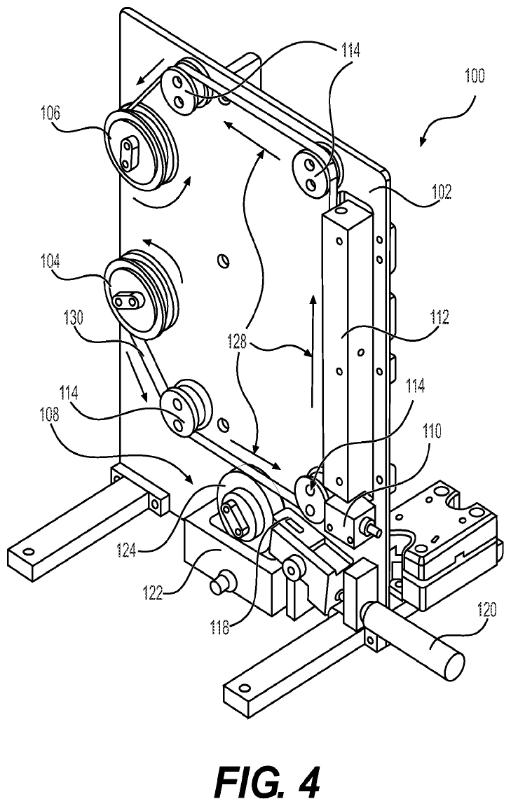

Referring again to FIGS. 3-4, in some embodiments, the coating element (108) can comprise a reagent reservoir (122) operably coupled to the support frame (102); a coating wheel (124) rotatably coupled to the support frame (102) and configured to transfer a coating reagent from the reagent reservoir (122) to a surface of the tape (130) being drawn along the path (128) from the feeder reel (104) to the take-up reel (106) upon rotation; a coating motor (126) operably coupled to the coating wheel (124) so as to drive rotation of the coating wheel; and a thickness control (118) coupled to the coating wheel (124) such that adjustment of the thickness control selects an amount of the coating reagent transferred from the reagent reservoir (122) to the surface of the tape (and by extension coating thickness). In some embodiments, at least one electronic control unit can control a speed of the coating motor (as discussed in more detail below). The coating element can further comprise a micromanipulator (120) coupled to the thickness control (118) that allows for actuation of the thickness control (and by extension control over coating thickness). In some embodiments, the micromanipulator and thickness control, in combination, can provide for sub-micron selection and control over coating thickness.

In some embodiments, the coating reagent can comprise a graphene ink (e.g., graphene, graphene oxide, reduced graphene oxide, or a combination thereof dissolved or dispersed in a solvent). It is understood that any solvents known in the art effective to provide the desired composition can be utilized. In certain aspects, the solvent can be organic or inorganic.

In certain aspects, the solvent comprises dimethylformamide (DNF), N-methyl-2-pyrrolidone (NMP), ethylene glycol, (EG), alcohol organic solvent (for example, and without limitation, ethanol, isopropanol, n-butanol, etc.), terpenes and derivatives thereof (for example, a terpineol), ester organic solvents (for example, and without limitation, ethyl acetate, butyl acetate, ethylene-propylene acetate, and the like), benzene based organic solvents (for example, and without limitation, methylbenzene, dimethylbenzene and the like), ketone-based organic solvents (for example, and without limitation, cyclohexenone, cyclohexanone, acetone, methylethylketone, butanone and the like), or any combination thereof. In yet further aspects, the solvent can comprise cyclohexenone, a terpineol, isopropanol, or any combination thereof.

In still further aspects, the composition can further comprise additional additives. In such aspects, the additives can comprise surfactant agents, pH stabilizers, reinforcing agents, antifoaming agents, rheology modifiers, thickeners, and the like. It is understood that the additives are selected based on their effect on the quality of the final coating. It is also understood that the type of additives and their amounts need to be selected to reduce their impact on the optical, electrical, and mechanical properties of the final coating. In still further aspects, the surfactant can be ionic or nonionic, depending on the solvent. In still further aspects, the composition can further comprise a rheology modifier. It is understood that any known in the art rheology modifiers can be used. In certain exemplary and unlimiting aspects, the rheology modifier can comprise ethyl cellulose, which can serve as a rheology modifier (thickener).

In certain embodiments, the graphene ink can comprise graphene, graphene oxide, and/or reduced graphene oxide present in the composition in an amount from about 1 mg/mL to about 25 mg/mL, including exemplary values of about 2 mg/mL, about 3 mg/mL, about 4 mg/mL, about 5 mg/mL, about 6 mg/mL, about 7 mg/mL, about 8 mg/mL, about 9 mg/mL, about 10 mg/mL, about 11 mg/mL, about 12 mg/mL, about 13 mg/mL, about 14 mg/mL, about 15 mg/mL, about 16 mg/mL, about 17 mg/mL, about 18 mg/mL, about 19 mg/mL, about 20 mg/mL, about 21 mg/mL, about 22 mg/mL, about 23 mg/mL, and about 24 mg/mL. It is understood that the graphene, graphene oxide, and/or reduced graphene oxide can be present in the composition in any amount between any two foregoing values. It is still understood that the concentration of the graphene, graphene oxide, and/or reduced graphene oxide in the composition can be dependent on the specific properties of the final film.

In still further aspects, the coating reagent prior to application can be a uniform suspension. It is understood that to obtain a uniform suspension, any known in the art methods can be utilized, including without limitation, sonication, Vortex mixing, impeller mixing, and the like.

The drying element, when present, can comprise any suitable drying element.

In some cases, the drying element can render the tape and coating substantially free of moisture and/or solvent. In such aspects, it is understood that the less than about 10%, less than about 8%, less than about 5%, less than about 1%, less than about 0.5% of the moisture and/or solvent is present following drying. In still further aspects, the substantially free of moisture substrate can be formed by heating the substrate by any known in the art methods. In some aspects, the heating element can comprise a conventional heater, an IR heater, UV heater, or any combination thereof. In certain aspects, the drying element can comprise a gas diffuser.

The heating element can comprise any suitable heat source (e.g., a heating block) that can anneal the coating reagent. The heating element can be configured to anneal the coating reagent at a temperature from about 250-300° C., including exemplary values of about 260° C., about 270° C., about 280° C., and about 290° C.

In some embodiments, the feeder reel is operably coupled to a feeder motor such that the feeder motor can drive rotation of the feeder reel; and the take-up reel is operably coupled to a take-up motor such that the take-up motor can drive rotation of the take-up reel. In some embodiments, the feeder reel is operably coupled to the feeder motor via a rod extending through the support frame, the take-up reel is operably coupled to the take-up motor via a rod extending through the support frame.

In some embodiments, at least one electronic control unit can control respective speeds of the feeder motor, the take-up motor, and/or the coating motor (when present). A graphical user interface (GUI) can be operably connected to the electronic control unit(s) and configured to receive data entry for programming the electronic control unit. The data entry can comprise, for example, speed selections for the feeder motor, the take-up motor, and/or the coater motor (when present). In some embodiments, one or more of the motors is an encoded stepper motor.

In still further aspects, the substrate (tape) is cleaned prior to application of a coating reagent. In such aspects, the cleaning step can be done by any known in the art methods.

In some cases, the tape can be cleaned prior to placing the tape in the reel-to-reel coater. In other embodiments, a cleaning element can be integrated into the system. The cleaning element can be coupled to the support frame and positioned interface with the tape at a point along the path from the feeder reel to the take-up reel at a point between the feeder reel and the coating element. In some examples, the cleaning element can apply an organic or inorganic solvent to remove contaminants from the tape (and optionally also dry the tape).

If desired, the tapes can be run through the coaters multiple times in sequence to apply multiple coating layers on the tape. For example, the tape can be advanced through the coater at least 2 times, at least 3 times, at least 4 times, at least 5 times, at least 6 times, at least 7 times, at least 8 times, at least 9 times, or at least 10 times to form at least 2, at least 3, at least 4, at least 5, at least 6, at least 7, at least 8, at least 9, or at least 10 conductive carbon (e.g., graphene) layers on the tape.

Carbon-Coated Tapes

The devices described herein can be used to fabricate conductive carbon-coated (e.g., graphene-coated) tapes for use as substrates in electron microscopy. In some aspects, tapes formed by the devices described herein can comprise: a) a substrate having a first surface and an opposed second surface, and b) a conductive carbon coating (e.g., a graphene coating) disposed on the first surface of the substrate, wherein the tape is configured to support a sample for reel-to-reel electron or optical microscopy (e.g., in the form of a tape wound on a reel). In some aspects, the substrate can comprise a polymer film or a metal.

In certain aspects, the substrate can comprise a metal. It is understood that the metal can be any metal known in the art. In still further aspects, the metal substrate comprises any metal commonly used in the spectroscopic methods. In certain exemplary aspects, the metal substrate can comprise gold, copper, or nickel. In certain aspects, the metal substrate can comprise a continuous metal film/foil or a metal mesh. In certain aspects, the metal substrate can have a thickness from about 2 microns to about 50 microns, including exemplary values of about 5 microns, about 10 microns, about 12 microns, about 15 microns, about 18 microns, about 20 microns, about 22 microns, about 25 microns, about 28 microns, about 30 microns, about 32 microns, about 35 microns, about 38 microns, about 40 microns, about 42 microns, about 45 microns, and about 48 microns. It is understood that the metal substrate thickness can be any thickness between any two foregoing values.

In still further aspects, the substrate can be a polymer film. In certain aspects, a type of polymer can depend on the desired application. In certain aspects, the polymer is a polyimide, a polyethylene, a polyester, or a polycarbonate. In still further aspects, the polyimide polymer can comprise a poly(4,4′-oxydiphenylene-pyromellitimide) (or Kapton®). In still further aspects, the polymer is a polycarbonate. In yet still further aspects, the polymer is polyethylene terephthalate (PET). In yet other aspects, the polymer film can have a thickness of from about 2 microns to about 300 microns, including exemplary values of about 5 microns, about 10 microns, about 15 microns, about 20 microns, about 30 microns, about 50 microns, about 100 microns, about 150 microns, about 200 microns, and about 250 microns. It is understood that the polymer film thickness can be any thickness between any two foregoing values.

It is understood, and as described herein, graphene is a carbon material having a crystal structure in which hexagonal skeletons of carbon are spread in a planar form and is one atomic plane extracted from graphite crystals. As described herein, the term graphene includes a single-layer graphene and multilayer graphenes, including two to a hundred layers. The single-layer graphene refers to a sheet of one atomic layer of carbon molecules having π bonds.

In still further aspects, the graphene layer can comprise graphene oxide (GO).

In still further aspects, the graphene layer of the current disclosure comprises a reduced graphene oxide (rGO). It is understood that the reduced graphene oxide, as used herein, substantially resembles the pristine graphene in at least its lattice structure.

It is understood that the level of GO reduction, and thus resultant conductivity of the produced rGO can be manipulated by process conditions.

It is understood that the reduced graphene oxide can comprise from about 1% to about 30% by atomic weight of oxygen, including exemplary values of about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, and about 29% by atomic weight of oxygen. It is further understood that oxygen can be present in the disclosed reduced graphene oxide in any value between any two foregoing values.

In still further aspects, the reduced graphene oxide, as disclosed herein, can be substantially free of defects.

In still further aspects, when the disclosed reduced graphene oxide comprises oxygen, the oxygen can be present as bounded to carbon. In such aspects, the reduced graphene oxide comprises a carbonyl group, a carboxyl group, an epoxy group, or a combination thereof. It is understood that the chemical structure of the reduced graphene oxide can be evaluated by various spectroscopic techniques. For example, and without limitation, by use of XPS (X-ray photoelectron spectroscopy), EDS (Energy Dispersive X-ray Spectroscopy), Raman spectroscopy, etc. In yet further aspects, the amount of oxygen can be controlled by a degree of reduction of the graphene oxide and depending on the desired application.

In still further aspects, the reduced graphene oxide can be a multilayer reduced graphene oxide. In such exemplary aspects, the interlayer distance between the layers is greater than or equal to 0.34 nm and less than or equal to 0.5 nm, including exemplary aspects, of about 0.35 nm, about 0.36 nm, about 0.37 nm, about 0.38 nm, about 0.39 nm, about 0.4 nm, about 0.41 nm, about 0.42 nm, about 0.43 nm, about 0.44 nm, about 0.45 nm, about 0.46 nm, about 0.47 nm, about 0.48 nm, and about 0.49 nm.

In still further aspects, the conductive carbon layer (e.g., the graphene layer) can have a thickness from about 1 nm to about 5 microns (e.g., from about 1 nm to about 1.5 microns), including exemplary values of about 2 nm, about 5 nm, about 7 nm, about 10 nm, about 15 nm, about 20 nm, about 25 nm, about 30 nm, about 50 nm, about 100 nm, about 150 nm, about 200 nm, about 250 nm, about 300 nm, about 350 nm, about 400 nm, about 450 nm, about 500 nm, about 600 nm, about 700 nm, about 800 nm, about 900 nm, about 1 micron, about 1.1 microns, about 1.2 microns, about 1.3 microns, about 1.4 microns, about 1.5 microns, about 1.6 microns, about 1.7 microns, about 1.8 microns, about 1.9 microns, about 2 microns, about 2.5 microns, about 3 microns, about 3.5 microns, about 4 microns, and about 4.5 microns. It is understood that the graphene layer can have any thickness between any two foregoing values. For example, and without limitation, the thickness of the graphene layer can be about 55 nm, about 102 nm, about 220 nm, about 650 nm, about 950 nm, or about 1.150 microns.

In still further aspects, the graphene layer can have a sheet resistance of from about 25 Ohm/square to about 100 Ohms/square, including exemplary values about 30 Ohm/square, about 35 Ohm/square, about 40 Ohm/square, about 50 Ohm/square, about 60 Ohm/square, about 70 Ohm/square, about 80 Ohm/square, and about Ohm/square. In yet some exemplary aspects, the sheet resistance can be about 45 Ohm/square.

In still further aspects, the tape having a graphene coating can have a sheet resistance of from about 25 Ohm/square to about 100 Ohms/square, including exemplary values about 30 Ohm/square, about 35 Ohm/square, about 40 Ohm/square, about 50 Ohm/square, about 60 Ohm/square, about 70 Ohm/square, about 80 Ohm/square, and about Ohm/square.

In still further aspects, the graphene coating can be a substantially uniform film. In such exemplary aspects, the term “uniform film” refers to a film having little to no deviation in the thickness of the film. In still further aspects, the thickness of the film deviates in various spots on the substrate for less than about 5%, less than about 3%, less than about 1%, or less than about 0.5%. In yet further aspects that graphene coating is substantially free of defects.

In still further aspects, the graphene coating can be substantially mechanically flexible. In still further aspects, the graphene coating can be substantially bendable. In yet other aspects, the graphene-coated tape can be substantially mechanically flexible. In still further aspects, the graphene-coated tape can be substantially bendable. In still further aspects, the graphene coating can substantially eliminate charging artifacts resulting from an electron beam in electron microscopy. In still further aspects, the graphene coating can be effectively invisible in a resolution range for optical microscopy.

Examples of substrates that can be formed using the reel-to-reel coaters described herein are described, for example, in WO 2020/123597, which is incorporated herein by reference in its entirety. In some cases, the tapes can serve as grids for use in imaging.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1: Reel-to-Reel Coater for the Fabrication of Graphene-Coated Tapes

Summary

Electron microscopy has witnessed significant development over the past few years, however the resolution is limited by the properties of specimens. The imaging performance of electron microscopes depends upon the optimized sample preparation techniques as well as better support films. The selected topics include use of mechanically flexible and bendable graphene coated conductive support film. This film holds the specimen, permits nanoscale imaging, and eliminates sample instability and charging resulting from the electron beam in electron microscopes. Graphene provides supports of single atom thickness, extreme physical stability, periodic structure, and much higher electrical conductivity. The electrical conductance of the graphene film is measured as a function of the thickness of the films. Typically, for ˜5-10 nm thickness, a sheet resistance of less than 45 Ohm/square is achieved. From the C1s spectra acquired from X-ray photoelectron Spectroscopy, the graphene coated film contains sp2-hybridized carbon bonded to different oxygen functional groups (C—OH, C—O, C═O and O—C═O). These support films can be used in scanning electron microscopes as a conductive specimen mount and in Transmission electron microscope as a conductive and electron beam transparent grids.

Introduction

High-resolution transmission electron microscope (HR-TEM) and scanning electron microscope (SEM) are used to examine the structure, composition, and functional characteristics of specimens in submicron detail. There has been a tremendous improvement in instrumentation of electron microscopy with the development of hardware aberration correction and cold field emission gun (cFEG) technology. However, imperfections in the sample preparation often become the limiting factor. Therefore sample preparation method and sample support substrate plays a vital role in enhancement of the spatial resolution of the specimen to determine the structural and functional information.

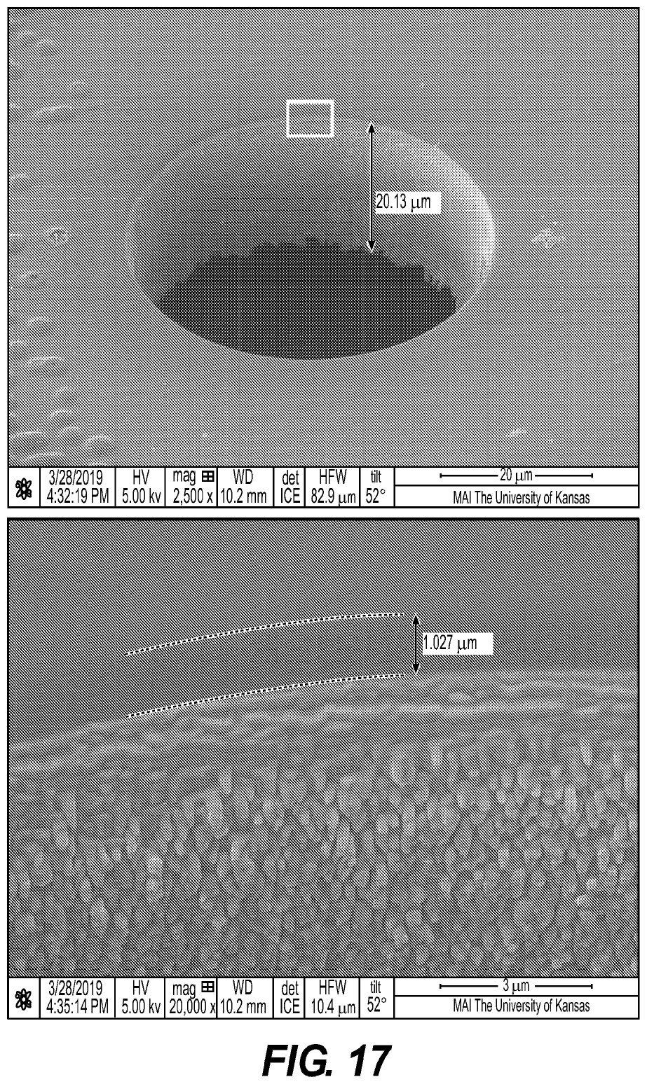

The characterization of insulation materials is a well-known challenge in terms of electron microscopy; sample surface charging and electron beam damage are common problems. Insulating samples do not provide a path to ground and therefore accumulate charge. As a result of charge accumulation the images demonstrate a truncation of resolution resembling that of specimen shift. The charge can also be compensated either by modifying sample or sample conditions. The most common approach for modification of sample is by coating the sample with a layer of conductor. However, conductive coating of sample surface could limit the extrapolation of structural details. The modification of sample condition is by lowering the beam energy and chamber pressure. However, lower beam energy will produce a dimmer Image and lower vacuum will reduce the image resolution. Therefore the most effective approach to reduce or prevent charging to minimum is to increase the conductivity of the sample during its preparation. Thin amorphous carbon as a support has been reported to reduce charging and improve the stability of embedded tissue and cell sections. The amorphous carbon support grids are widely used in current and emerging methods in life science TEM. However, amorphous carbon is a semiconductor rather than metal, and also suffers significantly reduced conductivity. Graphene, a single atomic layer of carbon with a hexagonal crystal structure, has been heavily investigated in the past decade for its many unique material properties. With its high electrical and thermal conductivity, near optical transparency, and high mechanical strength, graphene is considered a very promising 2D material for a broad range of applications, including energy storage, optical displays and sensors. Graphene has tremendous interest in crystalline TEM supports. Therefore deposition of crystalline graphene oxide support on TEM grids make it highly conductive support and enhances the imaging resolution of both biological and material sciences electron microscopy. For ˜1 μm thickness of graphene (FIG. 17), a sheet resistance of less than 45 Ohm/square is achieved and demonstrated a good electrical conductivity with a 6 fold higher conductivity than recently published records.

Automated tape-collecting ultramicrotomy (ATUM) methods allow for automated collection of thousands of serial ultrathin sections of uniform quality that subsequently can be imaged with SEM. Currently, the most commonly used tape for ATUM is carbon coated (cc)-Kapton tape, but it has deficiencies due to a relatively high sheet resistance, non-uniform carbon coating that causes mottled surface resistance and scratches. Therefore, an improved alternative tape would have a valuable role in the field of ATUM-based serial section EM. Graphene shows great potential in optimizing the preparation of nano-materials and biological sample in electron microscopy. A graphene layer provides support of single atom thickness, periodic structure and demonstrate high electrical conductivity with relatively stable under the electron beam. In this manuscript we discuss and demonstrate some of the outstanding capabilities of graphene coated conductive film that holds specimens and eliminates charging resulting from electron beam in scanning electron microscopes, transmission electron microscopes and X-ray Photoelectron spectroscopy.

Currently, Graphene Oxide (GO) support films grids are commercially available and has been used widely for high resolution imaging of nanostructures. The crystalline nature of GO gives a characteristic diffraction pattern which can be used as a convenient calibration for the analysis of other samples either by high resolution TEM or electron diffraction. However all of the commercial TEM grids are only available on a mesh of Cu, Ni, Au or other material. These mesh elements causes the presence of the lighter elements in the specimen get dominated during the elemental analysis. In addition to that the mesh structure are not transparent to the electron beam, and as result it is not possible to acquire an image from a specimen larger than the mesh size. It has been a great challenge for the researcher in biological field to acquire a full image from the section of the specimen. In this manuscript our goal is to make a graphene coated conductive support film without any mesh, but with a defined sized punched holes across the support film. It eliminates the current limitation on sizes of the specimen image and the effect of higher elements on elemental analysis of the specimen.

Reel-to-Reel Coater

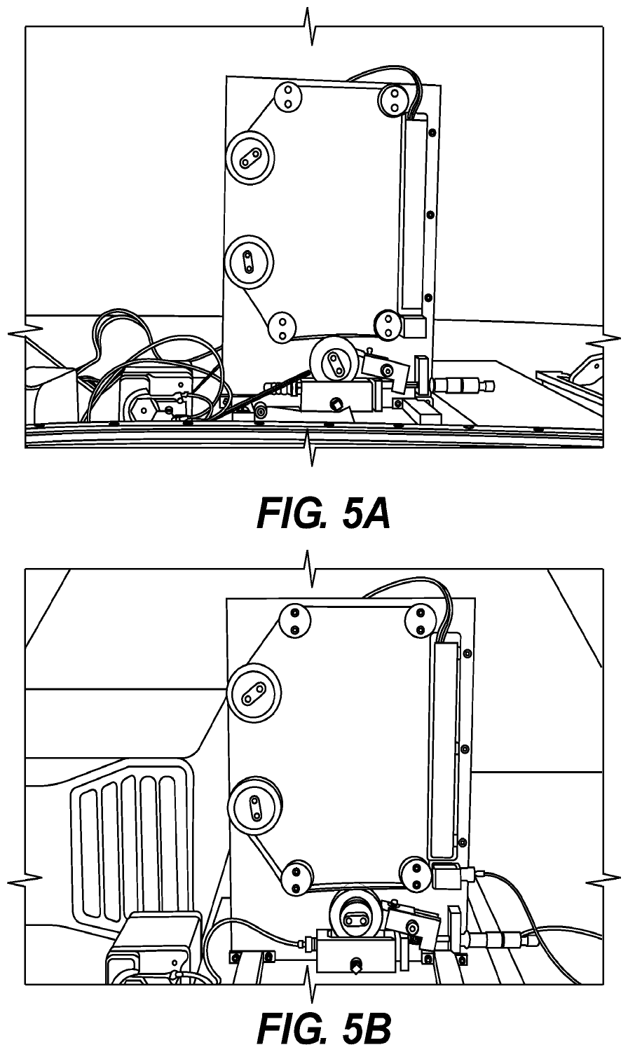

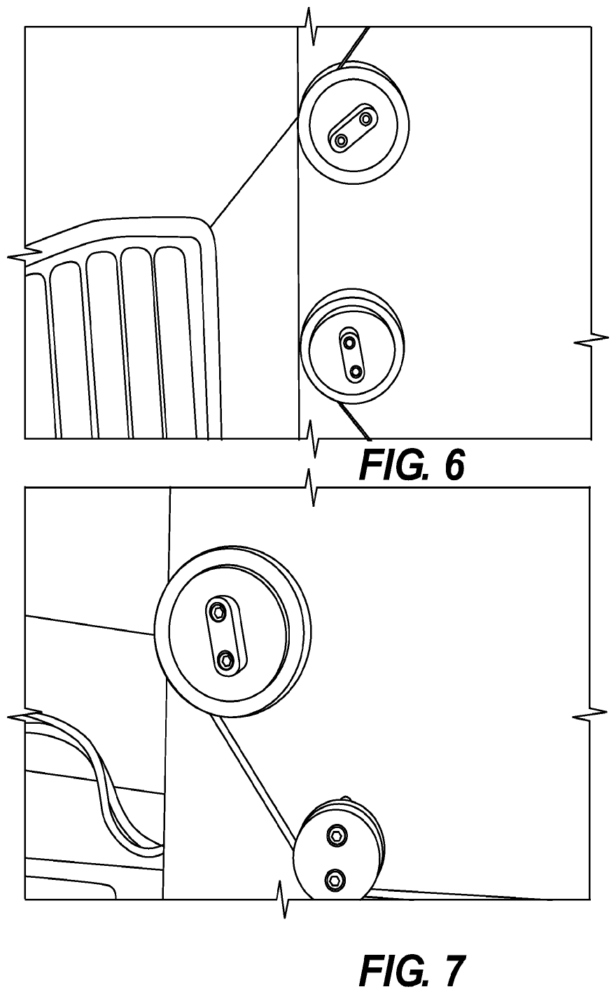

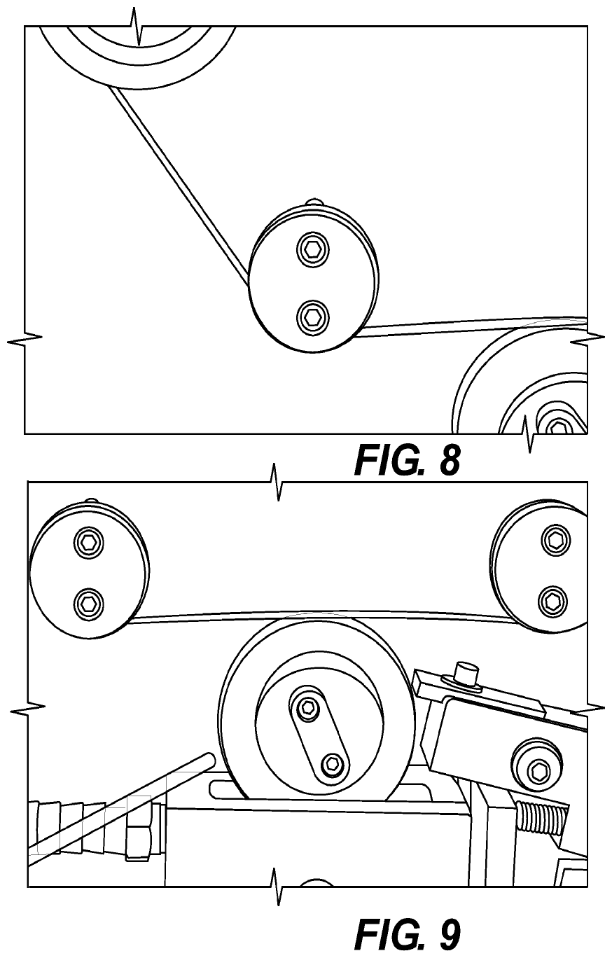

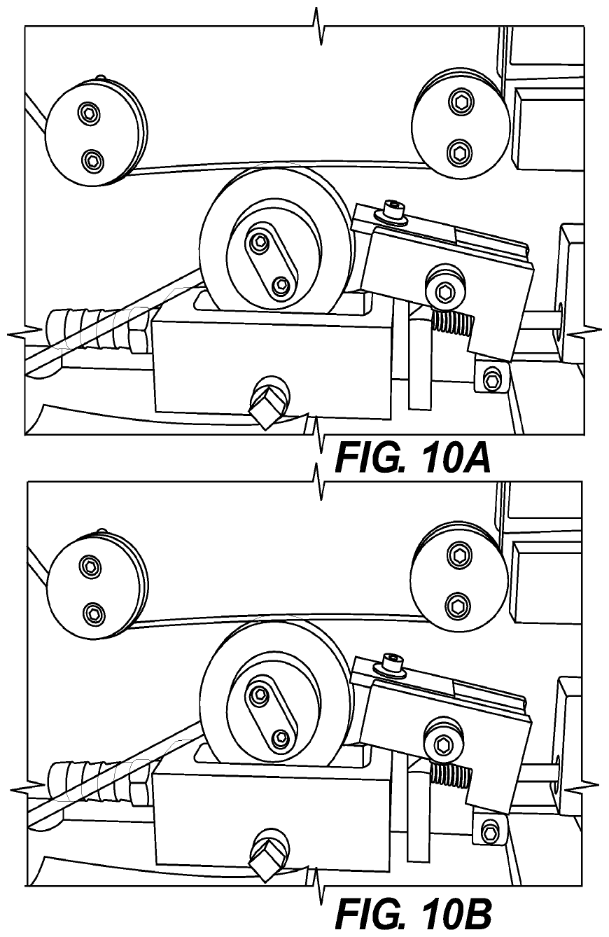

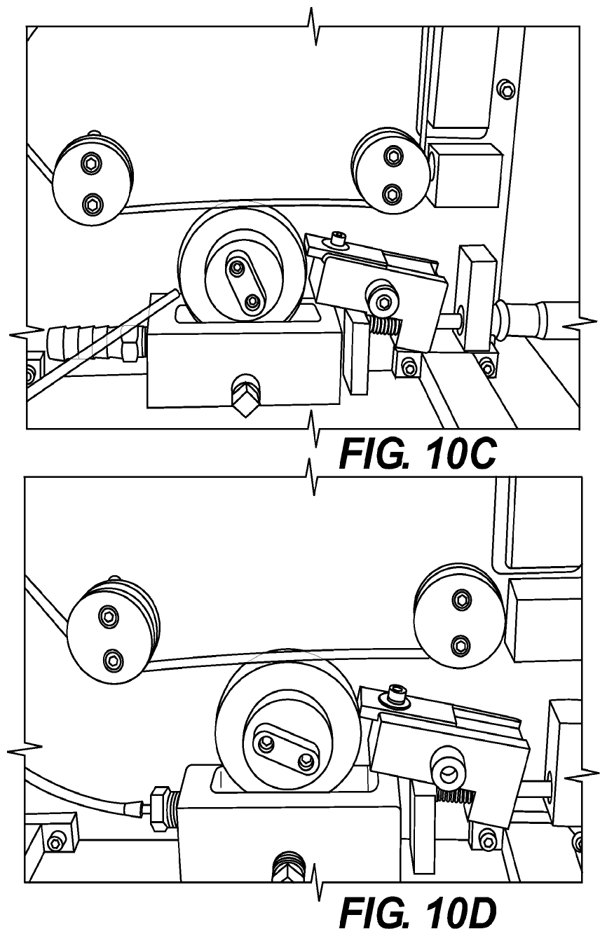

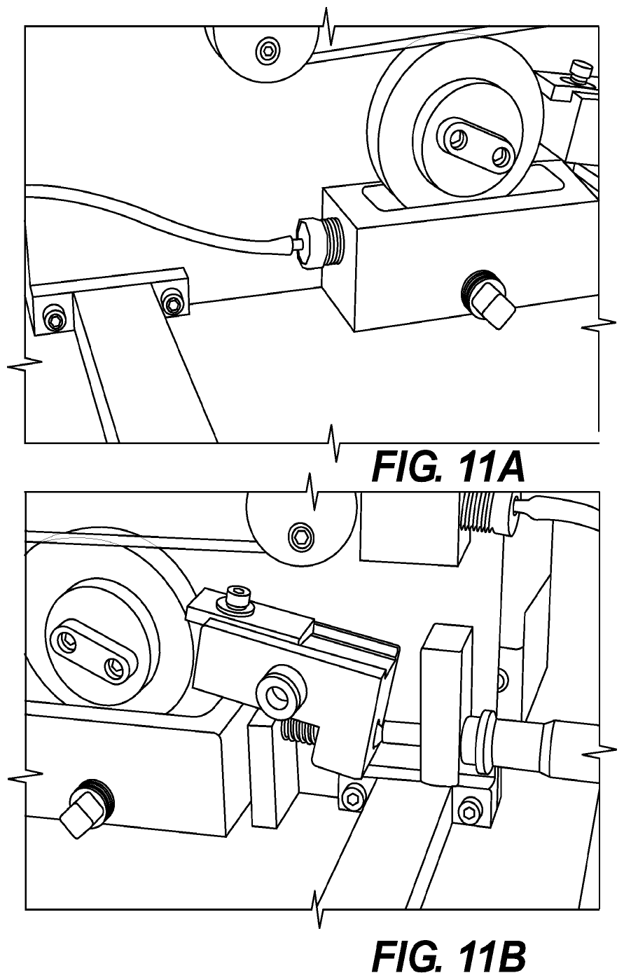

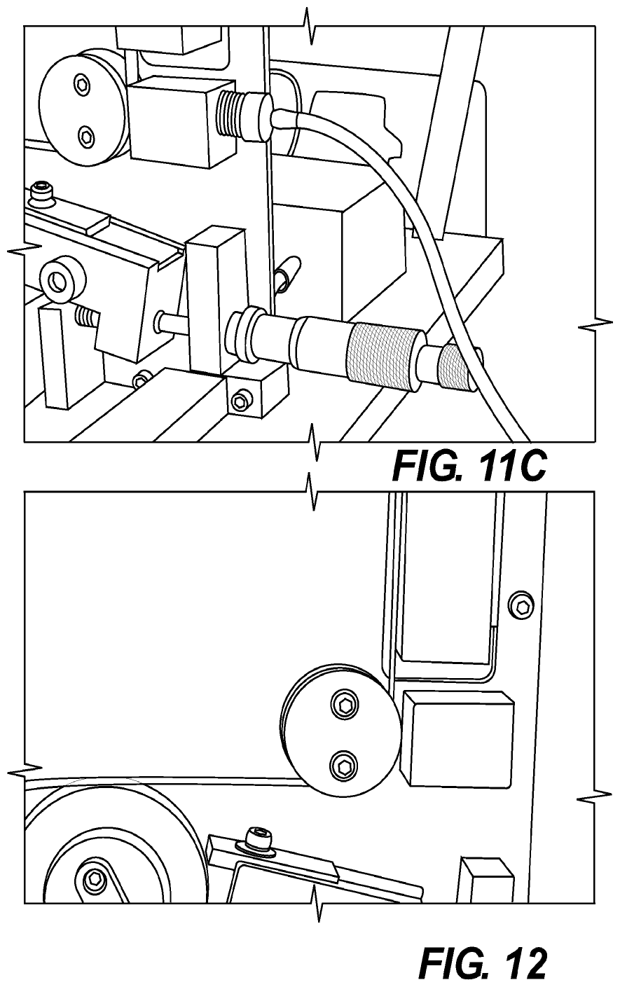

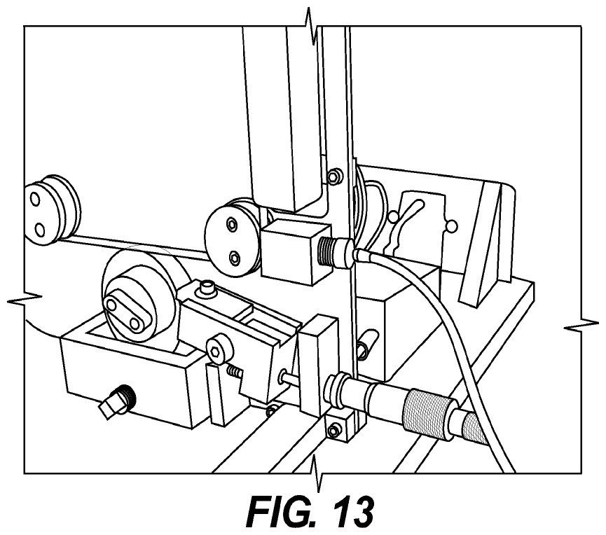

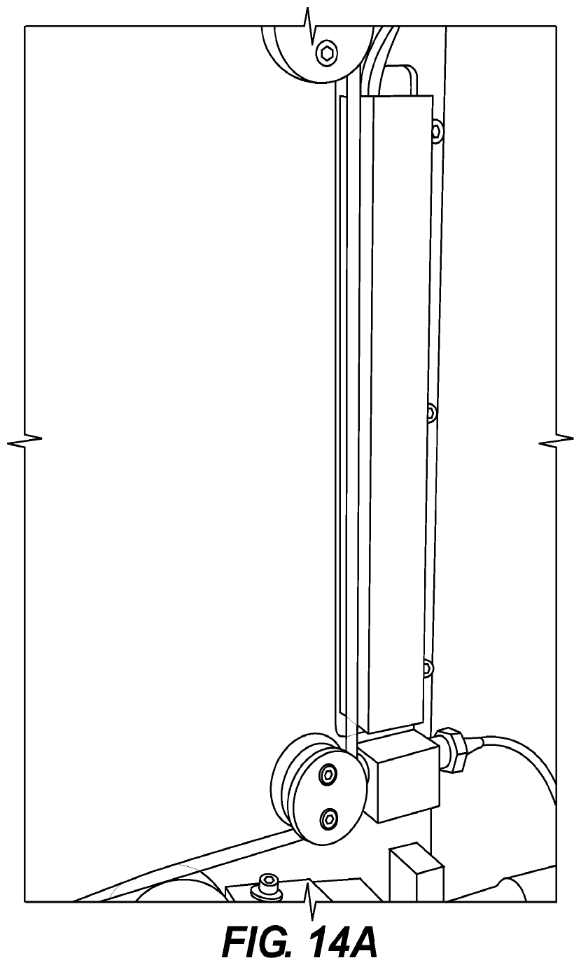

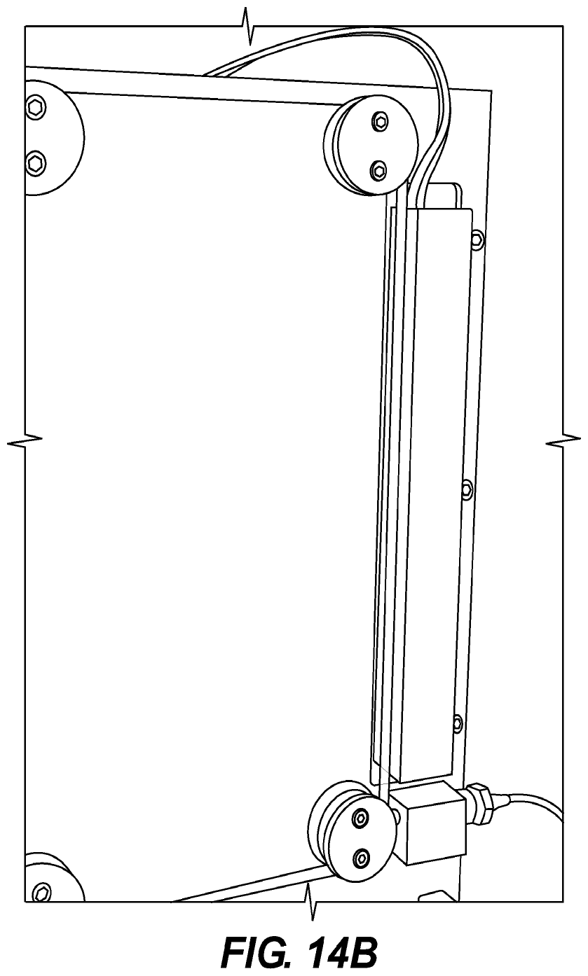

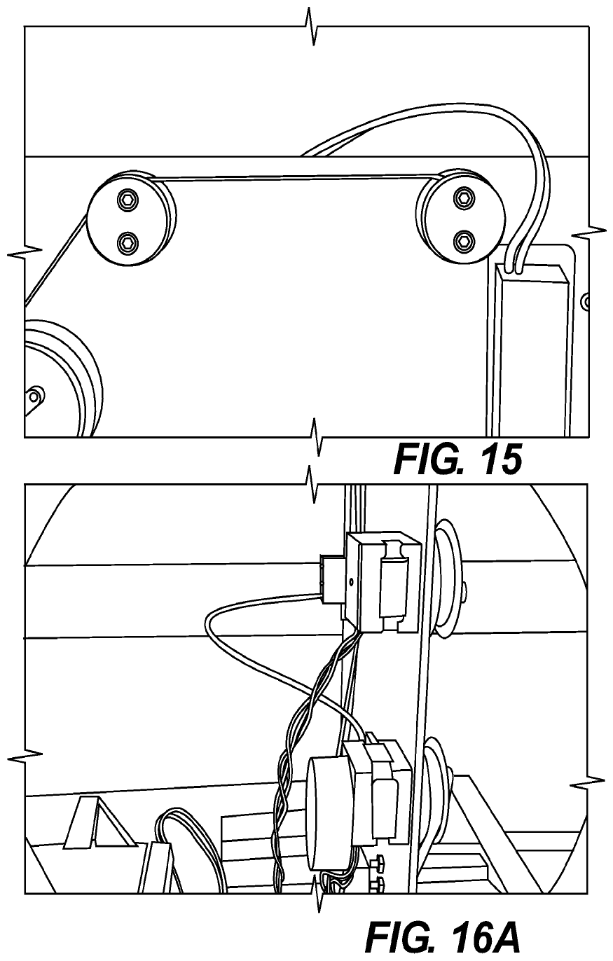

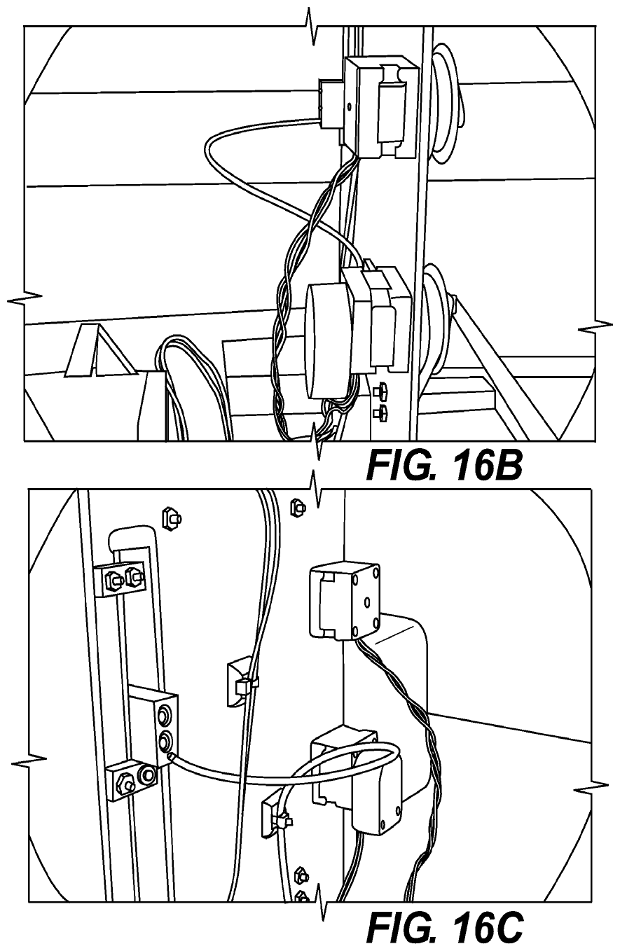

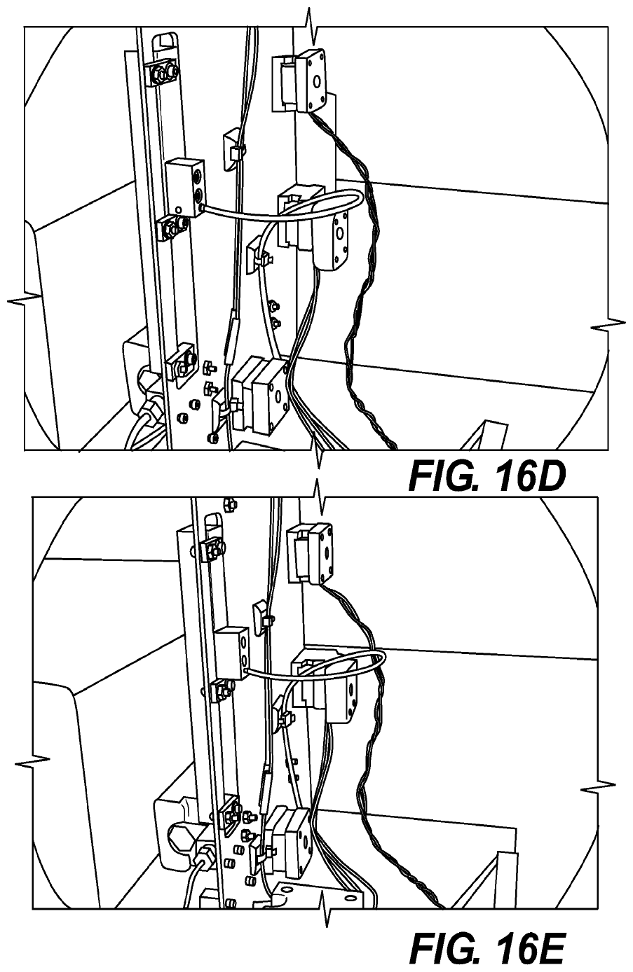

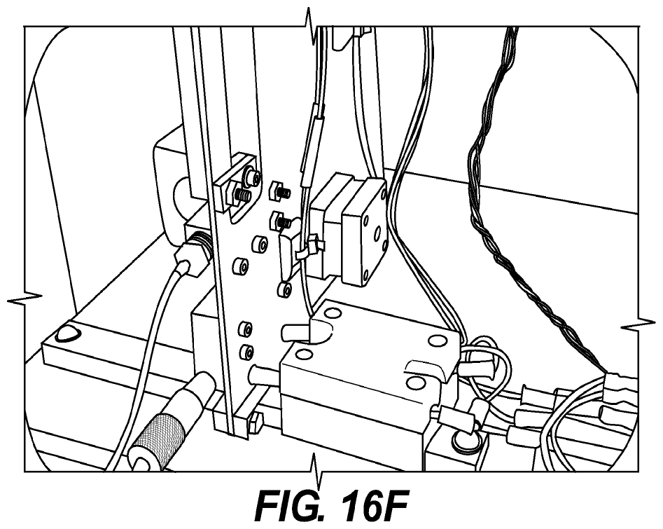

A stand-alone reel-to-reel coater for preparing graphene-coated tapes was constructed. FIGS. 5A-5B, 6, 7, 8, 9, 10A-10D, 11A-11C, 12, 13, 14A-14B, 15, and 16A-16F illustrate the example reel-to-reel coater.

The coater was used to form a conductive coating (i.e., graphene, graphene oxide, or a combination thereof) on Kapton® polyimide tape (from 5 cm to 300 m long, 0.5-mil Polyimide [Kapton®] Film No Adhesive 6.4 mm [¾″] wide×33 m [36 yd] long (PIT0.5N/6.4). The reel-to-reel coater is illustrated in FIGS. 5-16F. The example coater includes the following components:
(1) a plurality of stainless steel screws and washers, compression springs, extreme-temperature ceramic screws and washers, electrical-insulating ceramic sleeve screws and washers, position-control DC motors, aluminum and teflon reels, wheels, guides, heating block (120V AC; 6″ long heating element; 300 W) bolted to a reinforced square aluminum frame;
(2) a reinforced aluminum square reel-to-reel frame comprising three aluminum reels that is machined and assembled comprising respective hubs for wrapping, guiding, and accumulating uncoated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of a coated Kapton® polyimide tape extending between the feeder-reel, adjustable guide-wheels, stationary wheels, and the take-up reel;
(3) a aluminum feeder-reel that is machined and assembled aluminum comprising respective hubs for wrapping uncoated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of a coated Kapton® polyimide tape extending between the feeder-reel, adjustable guide-wheels, stationary wheels, and the take-up reel;
(4) a aluminum take-up-reel that is machined and assembled comprising respective hubs for wrapping coated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of the coated Kapton® polyimide tape extending between the feeder-reel, adjustable guide-wheels, stationary wheels, and the take-up reel;
(5) a aluminum coating wheel that is machined and assembled comprising respective hubs for wrapping coated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of a coated Kapton® polyimide tape extending between the feeder-reel, adjustable guide-wheels, stationary wheels, and the take-up reel;
(6) a adjustable teflon guide that is machined and assembled comprising respective hubs for guiding the uncoated and coated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of the uncoated and coated Kapton® polyimide tape extending between the feeder-reel, adjustable guide-wheels, stationary wheels, and the take-up reel;
(7) three stationary teflon guides that is machined and assembled comprising respective hubs for guiding the uncoated and coated Kapton® tape (from 5 cm to 300 m long, 0.5-mil Polyimide [Kapton®] Film No Adhesive 6.4 mm [¾″] wide×33 m [36 yd] long (PIT0.5N/6.4), the respective hubs having a calibrated circumference adapted to maintain a speed and a tension of the uncoated and coated Kapton® polyimide tape extending between the feeder-reel, adjustable guide-wheels, stationary wheels, and the take-up reel;
(8) a feeder-encoder motor that drives rotation of the feeder-reel;
(9) a take-up motor that drives rotation of the take-up reel;
(10) a reagent (i.e., “graphene nano-ink”) bath;
(11) a coating thickness micromanipulator adjuster to regulate the thickness of the graphene nano-ink thickness on the Kapton tape;
(12) a gas diffuser (i.e. argon) to dry the graphene nano-ink on the Kapton tape,
(13) a heating block for annealing the graphene nano-ink on the Kapton tape; and
(14) an electronic control unit including a 32-bit microcontroller with 512 Kbyte non-volatile memory, two position-control DC motor control circuits, motor position monitoring, heating and power regulation. The microcontroller accepts commands and operational parameters from an external computer which are translated to coordinated stepper motor motion. The motor rotation is actively monitored and continuously adjusted by the microcontroller to guarantee tape tension and a linear tape speed according to the coating thickness requirements. The microcontroller remembers settings and configurations when power is removed allowing for a rapid re-start of the coater. Power regulation ensures clean and steady power for reliable operation. Components and assemblies have been miniaturized for efficient use of lab bench space. Connectors have positive locking and polarity features for simplicity and security of assembly.

Reagent Composition

A graphene nano-ink was used as a reagent to form the graphene coating on the Kapton tape. To prepare the graphene nano-ink, 85% by volume of cyclohexanone was mixed with 15% by volume of terpineol (both from Sigma Aldrich). The solvent mixture was then mixed with reduced graphene oxide (also from Sigma Aldrich) in a 6 mg/mL ratio. Then, 3 mg/mL ethyl cellulose was added to the mixture (ethyl cellulose was purchased from Sigma Aldrich). The mixture was bath sonicated overnight at a temperature not exceeding 40° C. The mixture was then probe sonicated for 15 minutes, and vortex-mixed for another 5 minutes.

Deposition of Graphene Coating

To perform the graphene coating, 50 μL of the above “graphene nano-ink” is mixed with 5 mL of isopropanol. The “graphene nano-ink” and isopropanol are mixed using a bath sonicator (the vial lid kept closed completely to avoid any mechanically-thermally-induced evaporation of isopropanol) to produce a “diluted graphene nano-ink.” The 5 mL volume of the “diluted graphene nano-ink” is drawn from the vial and placed into the coater reagent bath. The coater wheel casts a thin layer of graphene non-ink onto the Kapton® tape. The graphene nano-ink coating is instantaneously dried using argon gas and then annealed to the Kapton tape at 300° C. in an argon atmosphere.

Characterization

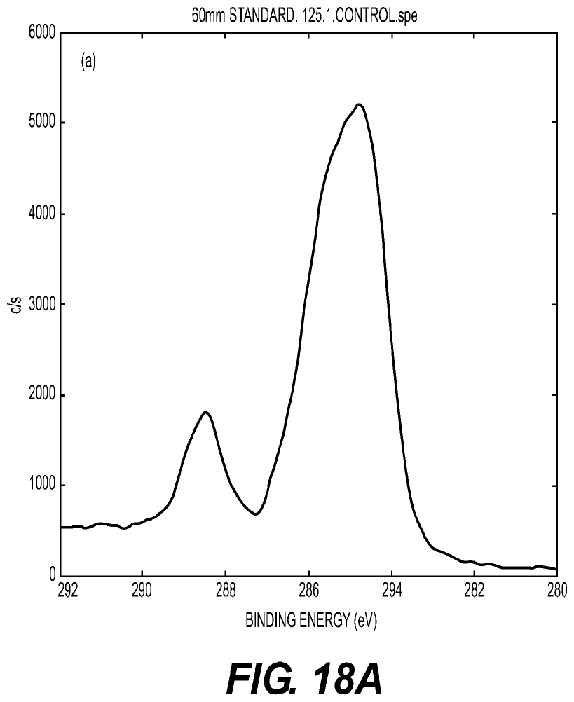

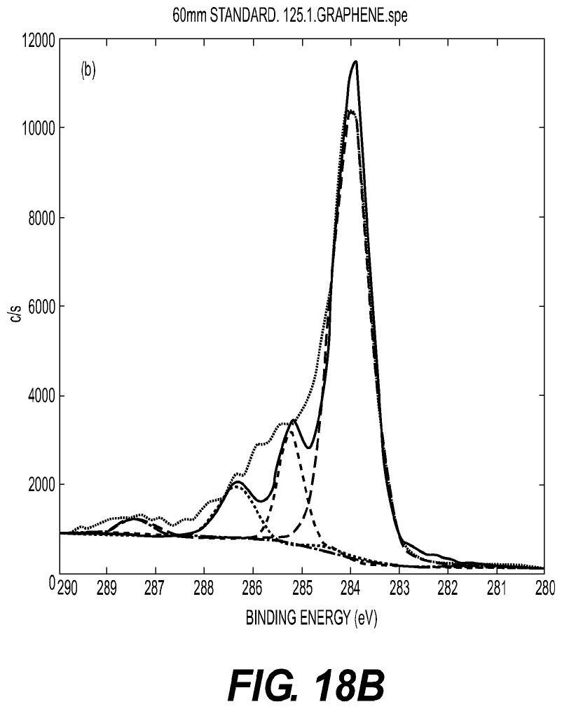

XPS: The Graphene-coated Kapton film was characterized by using an X-ray photoelectron spectroscopy (PHI 5000 VersaProbe II, Physical Electronics Inc.) at an ultrahigh vacuum (1×10⁻⁹ bar) instrument with a monochromated Alk_{□} X-ray source. The charge compensation was achieved with a combination of electron and argon ion flood guns. The X-ray beam size was 100 μm and survey spectra were recorded with pass energy (PE) of 117 eV step size 1 eV and dwell time 20 ms, whereas high-energy resolution spectra were recorded with PE of 47 eV, step size 0.1 eV and dwell time 20 ms. Auto-z (i.e., automated height adjustment to the highest intensity) was performed before each measurement to find the analyzer's focal point. The number of average sweeps of each of the elements was adjusted to (5-30 sweeps) to obtain the optimal signal-to-noise ratio. The data collected from XPS acquisition was analyzed using a Multipak software tool. The analyzed curve fit data obtained from C1s spectra of graphene coated Kapton film shows that the graphene coated tape contains sp2-hybridized carbon bonded to different oxygen functional groups (C—C, C—O, C═O and C—OH). FIGS. 18A and 18B represents the C1s spectrum of Kapton tape and graphene coated Kapton sheet respectively.

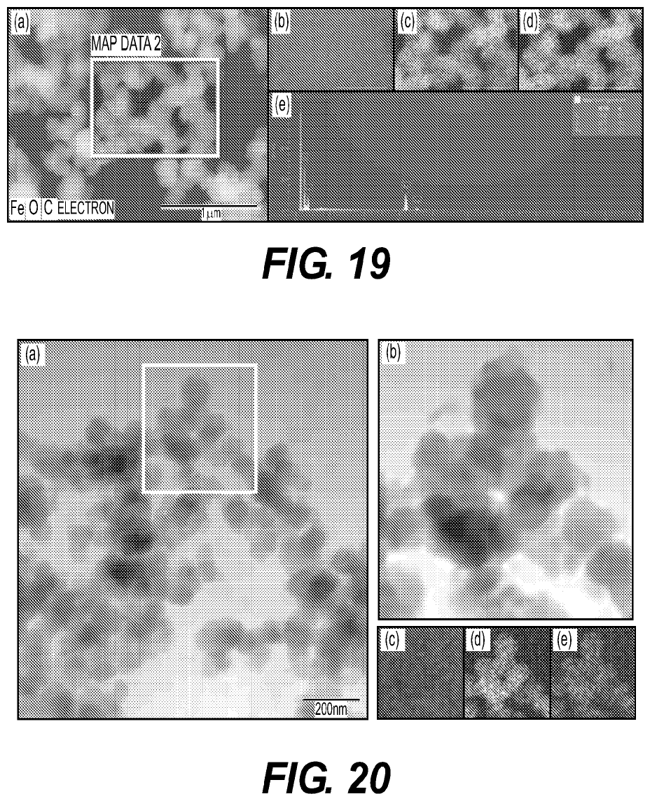

SEM-EDX: Powder form of Fe₂O₃ sample was sprayed on Graphene coated Kapton film and mounted on aluminum stub. A CFEG (cold field emission gun) SU8230 Scanning Electron Microscope (Hitachi High Technologies Corporation, Tokyo, Japan) with a silicon drift EDX detector (Oxford Instruments, X-Max^{N}, UK) was used to measure the surface morphology, elemental composition and distribution of all elements. All the SEM data reported were obtained at an acceleration voltage of 10 kV and the images were collected with a YAGBSE (Back Scattered Electron) detector. The elemental mapping and energy spectrums were acquired with Aztec tools (Oxford Instruments, UK). A high electron charge was observed in naked Kapton tape, however there was not much evidence of electron charge effect in graphene-coated Kapton film (FIG. 19). The shape and morphology of Fe₂O₃ particles was observed. The elemental maps of the element indicate a homogeneous distribution of the iron, and oxygen elements in the particles and carbon in the support Graphene film (FIG. 19).

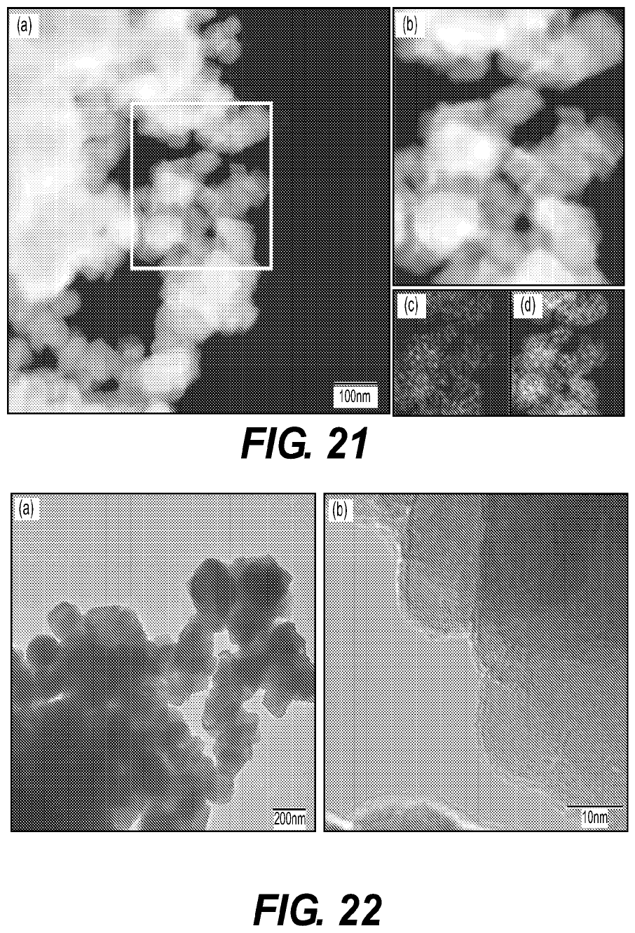

S/TEM: Scanning/Transmission electron microscopy (S/TEM) is an imaging technique in which a high energy electron beam is transmitted through a thin specimen. The transmission of the electron beam results in an enlarged image that can be used to obtain structural detail at the nanometer scale. Traditionally amorphous carbon supports are used on TEM grids to mount the specimen and glow discharge the grids to make the surface hydrophilic, disrupting the surface and introducing —OH and C═O groups. However Graphene TEM supports renders sufficiently hydrophilic with minimal structural attenuation and maintained electrical and thermal conductivity enhancing the transmitted beam intensity (FIG. 20). The hydrophilic surface of graphene helps to spread particles evenly across the grid. Therefore Graphene oxide film deposited support grids are becoming popular for high resolution imaging. A graphene coated Kapton film was punched to a size of (3×3) mm. A 5 μl of Fe₂O₃ solution is dropped on punched graphene-coated Kapton sheet, and was left to air-dry for several minutes prior to being examined using an FEI Tecnai G2 scanning transmission electron microscope (S/TEM) at an electron acceleration voltage of 120 kV (FIGS. 20 and 21). A S/TEM image of the Fe₂O₃ particles was acquired using High angle Annular Dark Field (HAADF) detector to study the size and morphology of the particles. The elemental maps of the element indicate a homogeneous distribution of the iron, and oxygen elements in the particles and carbon in the support Graphene film (FIGS. 20 and 21). The (3×3) mm graphene coated Kapton sheet was punched with a micro-needle to make several holes around the grid and again captured the high resolution TEM and S/TEM images of the Fe₂O₃ particles to study the crystalline structure and morphology of the particles (FIGS. 20, 21, and 22). The elemental maps of the element indicate a homogeneous distribution of the iron, and oxygen elements in the particles but there is not a presence of any extra elements besides the elements from the specimen (FIGS. 20 and 21).

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative compounds, components, compositions, and method steps disclosed herein are specifically described, other combinations of the compounds, components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A system for the fabrication of a carbon-coated tape, the system comprising:
a support frame;
a feeder reel rotatably coupled to the support frame;
a feeder motor operably coupled to the feeder reel so as to drive rotation of the feeder reel;
a take-up reel rotatably coupled to the support frame;
a take-up motor operably coupled to the take-up reel so as to drive rotation of the take-up reel;
a coating element, a drying element, and a heating element, each operably coupled to the support frame and spaced apart from the feeder reel, the take-up reel, and one another; and
one or more tape guides coupled to the support frame and defining a path for a tape to be drawn from the feeder reel to the take-up reel;
wherein the path allows the tape to sequentially interface with the coating element, the drying element, and the heating element while being drawn from the feeder reel to the take-up reel.

2. The system of claim 1, wherein the coating element comprises:
a reagent reservoir operably coupled to the support frame;
a coating wheel rotatably coupled to the support frame and configured to transfer a coating reagent from the reagent reservoir to a surface of the tape being drawn along the path from the feeder reel to the take-up reel upon rotation;
a coating motor operably coupled to the coating wheel so as to drive rotation of the coating wheel; and
a thickness control coupled to the coating wheel such that adjustment of the thickness control selects an amount of the coating reagent transferred from the reagent reservoir to the surface of the tape.

3. The system of claim 2, further comprising a micromanipulator coupled to the thickness control.

4. The system of claim 1, wherein the feeder reel is detachably connected to the feeder motor.

5. The system of claim 1, wherein the take-up reel is detachably connected to the take-up motor.

6. The system of claim 1, wherein the feeder reel and the take-up reel comprise aluminum wheels comprising respective hubs for wrapping the tape, the respective hubs having a calibrated circumference adapted to maintain a speed and a tension of the tape extending between the feeder reel and the take-up reel.

7. The system of claim 1, wherein the feeder reel and the take-up reel are made of aluminum and aluminum alloys comprising specified conductivity and specified magnetically shielding properties.

8. The system of claim 1, wherein the feeder reel and the take-up reel are adapted to be re-attached to an in-situ scanning electron microscope reel-to-reel imaging system, a reel-to-reel system for sectioning resin-embedded cells and/or tissues with an ultramicrotome, or any combination thereof.

9. The system of claim 1, further comprising at least one electronic control unit controlling respective speeds of the feeder motor and the take-up motor.

10. The system of claim 9, wherein the coating element comprises:
a reagent reservoir operably coupled to the support frame;
a coating wheel rotatably coupled to the support frame and configured to transfer a coating reagent from the reagent reservoir to a surface of the tape being drawn along the path from the feeder reel to the take-up reel upon rotation;
a coating motor operably coupled to the coating wheel so as to drive rotation of the coating wheel; and
a thickness control coupled to the coating wheel such that adjustment of the thickness control selects an amount of the coating reagent transferred from the reagent reservoir to the surface of the tape; and wherein the system further comprises at least one electronic control unit controlling a speed of the coating motor.

11. The system of claim 9, further comprising a graphical user interface connected to the electronic control unit and configured to receive data entry for programming the electronic control unit.

12. The system of claim 11, wherein the data entry comprises speed selections for the feeder motor and the take-up motor.

13. The system of claim 1, wherein one or more of the motors is an encoded stepper motor.

14. The system of claim 1, further comprising a length of tape connected to the feeder reel, extending along the path from the feeder reel to the take-up reel, and received by the take-up wheel.

15. The system of claim 14, wherein the tape comprises a polyimide tape.

16. The system of claim 1, wherein the coating element is configured to apply a graphene ink to a surface of the tape being drawn along the path from the feeder reel to the take-up reel.

17. The system of claim 1, wherein the coating element applies a coating reagent on a surface of the tape being drawn along the path from the feeder reel to the take-up reel.

18. The system of claim 17, wherein one applied, the coating reagent is dried by the drying element.

19. The system of claim 17, wherein one applied, the coating reagent is annealed by the heating element to form a conductive carbon coating.

20. The system of claim 19, wherein the conductive carbon coating has a thickness of from about 1 nm to about 1.5 microns.

21. The system of claim 19, wherein the conductive carbon coating comprises graphene, graphene oxide, reduced graphene oxide, or any combination thereof.

22. The system of claim 17, wherein the coating reagent comprises a graphene ink.

23. The system of claim 1, wherein the drying element comprises a gas diffuser.
